(19) United States
(12) Patent Application Publication
(10) Pub. No.: US 2005/0129081 A1
(43) Pub. Date: Jun. 16, 2005

(54) Laser gain module

(76) Inventors: Jurgen Erhard, Berlin (DE); Bernd Ozygus, Prinzregentenstrasse (DE)

Correspondence Address: KRIEGSMAN & KRIEGSMAN, 665 FRANKLIN STREET, FRAMINGHAM, MA, 01702, US

(21) Appl. No.: 10/504,019

(22) PCT Filed: Jan. 31, 2003
(86) PCT No.: PCT/DE03/00326

(30) Foreign Application Priority Data
Feb. 1, 2002 (DE) 102-04-796.0

(51) Int. Cl. H01S 3/091

(52) U.S. Cl. 372/71; 372/70

(57) ABSTRACT

Laser gain modules are for example used in the field of labeling and imprinting technology, in medical technology and in other fields. The aim of the invention is to provide a laser gain module that has a simple mechanical design and that allows for simultaneous pumping at several sites within active media. The inventive laser gain module is compact in design and does not impose any restrictions on the remaining design of the resonator. At least one beam manipulation element (3) has beam splitting capabilities and interlinks several beam paths within which the laser radiation is amplified by targeted terminal pumping.

The laser gain module is applicable, for example, in the fields of labeling and inscribing technology, in medical technology as well as in other fields.

It is known that diode-pumped solid-state lasers several years ago replaced flashlamp-pumped systems in the field of smaller outputs. In addition, within diode-pumped lasers, longitudinally pumped lasers—when compared with transversally pumped systems—have the advantage of an essentially higher efficiency with simultaneously better beam quality. A disadvantage of end pumping, of course, is the output power which is currently limited to 10 to 15 watts. There are various approaches for shifting this limit to higher powers. One approach to this is, e.g., the so-called tightly folded resonator (EP 0 401,054 A2). In this structure, the laser beam is folded very tightly so that it is adapted to the intensely astigmatic pump radiation of a laser diode. This type of resonator, of course, is very sensitive to adjustment and has not proven itself in practice. Multipath laser systems, e.g., are another approach (WO 96/17418). With these systems, it is possible to utilize several thermally separated pumped regions in a larger laser crystal employing a simple mechanical construction. A disadvantage of this arrangement is the mutual dependence of resonator length and radius of curvature of the output mirror. With these laser systems, it is possible only in a very limited way to produce good beam quality with simultaneously high output powers.

The present invention, with a mechanically simple construction, makes possible the simultaneous pumping of several sites within active media while circumventing the limitations present in multipath systems. The improvement is achieved by the fact that several beam paths, in which an intensification of the laser radiation takes place due to targeted end pumping, are combined with a beam manipulation element with beam divider properties, whereby the beam divider property—depending on the type of construction in each case—is provided by a semi-reflecting or wavelength-selective mirror, by a polarizer, a diffractive element or other component. In this way, coupled resonators are formed in general systems. In special cases, however, the individual intensifications in the active medium take place sequentially. In comparison to the multipath resonator concept, the present invention has the advantage of free choice of resonator and the advantage of better pumping effectiveness due to the—generally—coaxial course of pumped beam and laser beam.

The essential physical difference of the construction described here is the use of combined beam paths. The previously known systems are all based on multiple reflections, in which the sites of reflection are pumped in the active medium. In these known systems, the laser beams are not coaxial to the pumped beams, which leads to a poorer efficiency.

Additional features of the solution result from the patent claims.

The invention will be explained in more detail below on an example of embodiment. In the appended drawing:

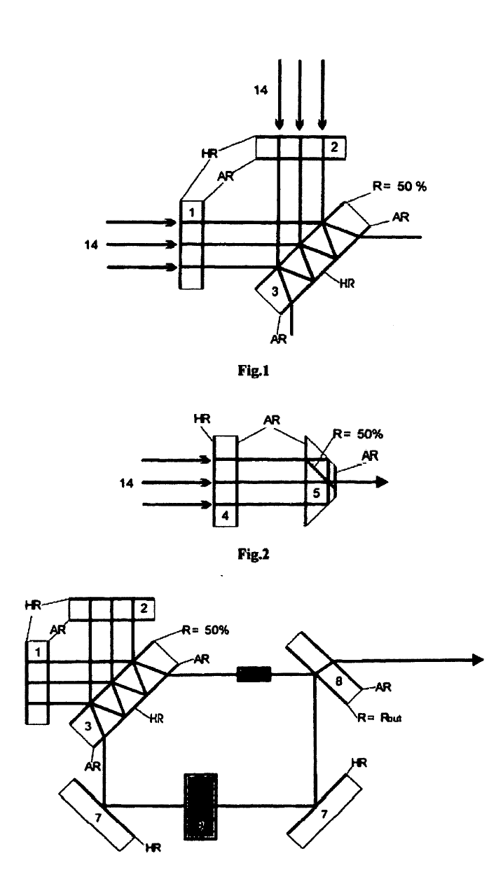

FIG. 1 shows a schematic representation of a laser gain module;

FIG. 2 shows an alternative embodiment according to FIG. 1 with a laser diode bar;

FIG. 3 shows the laser gain module according to FIG. 1 integrated in a laser resonator;

FIG. 4 shows the laser gain module according to FIG. 2 integrated in a linear resonator;

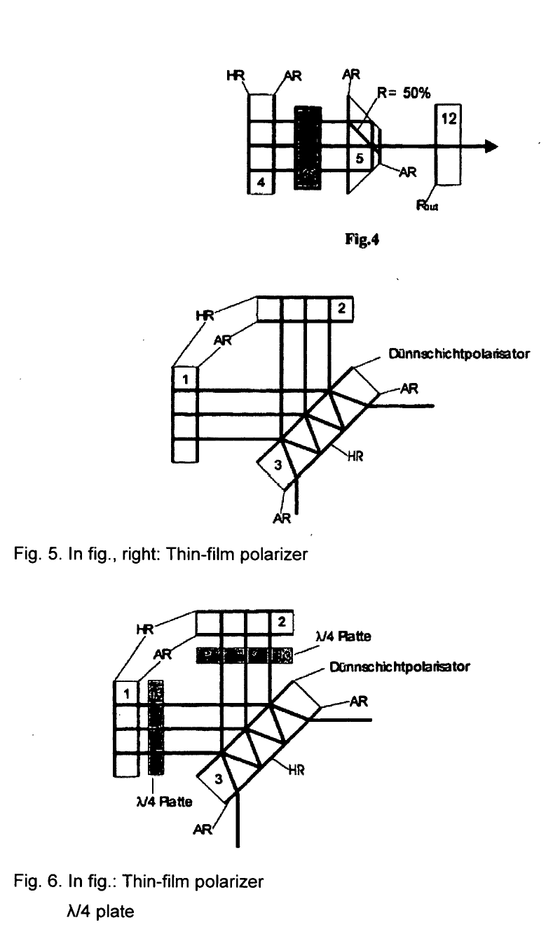

FIG. 5 shows the laser gain module according to FIG. 1 with a thin-film polarizer;

FIG. 6 shows a modified arrangement according to FIG. 5 with two time-lag plates.

An embodiment, which is pumped with two laser diode bars, is shown in FIG. 1. It is also important that the light of the laser diode bar is divided into several—in this example into three—pumped beams 14 (see also DE 197 18 933.4). Two active media 1 and 2 are pumped. The beam manipulation element 3 possesses on one side a semi-reflecting coating (in this example, 50%) and, on the other side, two separate regions with a highly reflecting coating (HR) and an anti-reflex coating (AR). The distance between the beams, which must correspond to the distance between the pumped regions, is given by the thickness and the refractive index of the material utilized. Correspondingly, the coupling element of the beam-forming optics utilized must be adapted to the pumped light.

An embodiment, which is pumped with one laser diode bar, is shown in FIG. 2. Again, the system is designed for three pumped beams 14. Only one active medium 4 is utilized (e.g., Nd:YAG). The coupling element 5 is designed in the form of a prism with flattened tips. In this embodiment, the semi-reflecting mirror is found inside the coupling element 5. There are two surfaces with an AR coating. An HR coating can be omitted in this case, since a total reflection occurs inside the prism. If the beam manipulation element is made of laser-active material, e.g., Nd:YAG or Nd:YVO₄, the complexity of the construction can once more be clearly reduced.

The laser gain module of FIG. 1 is shown inside a laser resonator in FIG. 3. In this case, the resonator is constructed as a ring resonator with an optical diode 9, two tilted mirrors 7, an output mirror 8 and a frequency doubler unit 10.

The laser gain module of FIG. 2 is shown inside a linear resonator in FIG. 4. In addition to the coupling element 5 and the active medium 4, a Q-switch 11—e.g., an acousto-optic modulator 11—is found in the resonator. This type of laser can be utilized, e.g., in inscription lasers or in externally frequency-doubled systems. The utilization of an output mirror 12 with an output reflectivity Rₒᵤₜ will probably not be necessary here, since the effective reflectivity of the beam manipulation element is sufficiently high.

FIG. 5 shows the laser gain module of FIG. 1 with a thin-film polarizer instead of a semi-reflecting mirror. This arrangement leads to the fact that only the polarization not reflected by the polarizer is intensified. The remaining polarization is reflected inside the beam manipulation element 3 and is not intensified. The beam paths, in which an intensification occurs, are coupled, as in the version with the semi-reflecting beam manipulation element.

Additionally, two λ/4 time-lag plates 13 are found in front of the active media 1 and 2 in FIG. 6. In combination with the thin-film polarizer, these lead to the fact that the polarization transmitted from the thin-film polarizer alternately passes through the three intensification regions in the two active media.

Basically 2 very different types of resonator can be produced from the beam manipulation element 3 with the active media 1. Another important property of the superstructures in which the different beam paths are coupled is the simultaneous existence of several resonator lengths. In this way, greater limitations to the resonance condition exist within the total resonator. The number of longitudinal modes is thus greatly reduced by a suitable choice of these lengths. For frequency-doubled lasers within the resonator, this has as a consequence a substantially improved stability of the output power.

1. A laser gain module, hereby characterized in that several beam paths, in which an intensification of the laser radiation occurs by targeted end pumping, are combined by means of at least one beam manipulation element with beam divider properties.

2. The laser gain module according to claim 1, further characterized in that the beam paths in which an intensification occurs run coaxially to the pumped beams belonging thereto.

3. The laser gain module according to claim 1, further characterized in that all beam paths or individual groups of beam paths in which an intensification occurs run parallel.

4. The laser gain module according to claim 1, further characterized in that at least one of the parallelly running groups of beam paths in which an intensification occurs is intensified in a common active medium.

5. The laser gain module according to 1, further characterized in that at least one of the interfaces of at least one beam manipulation element possesses semi-reflecting properties.

6. The laser gain module according to claim 1, further characterized in that at least one of the interfaces possesses a wavelength dependence such that different wavelengths can be intensified in the laser gain medium.

7. The laser gain module according to claim 1, further characterized in that at least one of the interfaces of at least one of the beam manipulation elements possesses polarizing properties.

8. The laser gain module according to claim 7, further characterized in that additionally, at least one element that influences polarization is disposed in at least one of the beam paths in which an intensification occurs.

9. The laser gain module according to claim 8, further characterized in that at least one of the elements found additionally in the beam paths in which an intensification occurs is a time-lag plate.

10. The laser gain module according to claim 1, further characterized in that at least one beam manipulation element with beam divider property is joined monolithically with at least one active medium.

11. The laser gain module according to claim 1, further characterized in that the beam manipulation element with beam divider property serves simultaneously as the active medium.

12. A laser resonator, hereby characterized in that at least one laser gain module according to claim 1 is disposed in the laser resonator.

13. The laser resonator according to claim 12, further characterized in that the different resonator lengths in the intensifier arms lead to a longitudinal one-mode operation.

14. The laser resonator according to claim 12, further characterized in that a frequency multiplication occurs inside the resonator.

15. The laser resonator according to claim 12, further characterized in that the resonator is passively Q-switched.

16. The laser resonator according to claim 12, further characterized in that the resonator is actively Q-switched.

17. The laser resonator according to one of claims 15 to 16, further characterized in that the beam manipulation element also takes over the function of the Q-switch.

18. The laser resonator according to claim 12, further characterized in that the laser can be simultaneously driven at several wavelengths.

19. The laser resonator according to claim 12, further characterized in that one or more of the simultaneously generated wavelengths is (are) frequency-multiplied inside the resonator.

20. The laser resonator according to claim 12, further characterized in that the different dimensions in the resonator are adapted in such a way that the laser can be driven coupled to mode, actively or passively, in order to generate ultrashort pulses.
